(19) United States
(12) Patent Application Publication
(10) Pub. No.: US 2023/0024435 A1
(43) Pub. Date: Jan. 26, 2023

(54) AUTONOMOUS MOBILE ROBOT

(71) Applicant: Kar-Han Tan, Palo Alto, CA (US)

(72) Inventor: Kar-Han Tan, Palo Alto, CA (US)

(21) Appl. No.: 17/871,854

(22) Filed: Jul. 22, 2022

Related U.S. Application Data
(60) Provisional application No. 63/224,755, filed on Jul. 22, 2021.

(51) Int. Cl. B25J 13/08; B25J 5/00; B25J 9/16

(52) U.S. Cl. CPC B25J 13/088; B25J 5/007; B25J 9/1674

(57) ABSTRACT

An autonomous mobile robot that is equipped with functionalities to assist the elderly and disabled patients to live at home in a way that is acceptable and desirable for the patients and caregivers is described. The robot provides safety monitoring, cognitive and communication support to patients. mobility to ensure availability, and a scalable platform. The robot is able to detect when the robot has toppled over and automatically execute operations that restore the robot to a full upright position.

### CROSS-REFERENCE TO A RELATED APPLICATION

This application claims the benefit of Provisional Application 63/224,755, filed Jul. 22, 2021.

### TECHNICAL FIELD

This disclosure is directed to robotics, and in particular, to autonomous mobile robots.

### BACKGROUND

Populations are aging in many countries around the world. In resent decades, there has been an increase in the percentage of older people living longer. Because people are living longer and older people are becoming an increasing larger proportion of the population, there is progressively insufficient availability of specialized caregivers and daily care. To complicate matters further. the number of people who are willing to serve as caregivers for the elderly has decreased. This development puts a tremendous burden not just on the elderly to sustain themselves, but also on existing caregivers and medical workers to server a growing elderly population. Those working in the health care industry seek low-cost effect ways of monitoring and assisting the increasing number of elderly people living at home.

### SUMMARY

This disclosure is directed to an autonomous mobile robot equipped with functionalities that assist elderly people and disabled patients to live at home in a way that is acceptable and desirable for elderly people. disabled patients. and caregivers. the robot described herein provides safety monitoring, cognitive and communication support, mobility to ensure availability, and a scalable platform. Because the robot is designed to server elderly and disabled people in a dynamic and changing environment, such as a home, the robot may be toppled over. The robot is able to detect when the robot has been toppled over and, without assistance, automatically execute operations that restore the robot to a full upright position. As a result. the robot is able to continue providing safety monitoring and cognitive and communication support to the elderly and patients the robot serves.

### DESCRIPTION OF THE DRAWINGS

FIGS. 1A-1B show two side-elevation views of an autonomous mobile robot (“robot”) 100 in an upright position.

FIGS. 1C-1D show top and bottom views, respectively, of the robot.

FIGS. 2A-2B show two views of the robot with a mobile base unit extended outside the body of the robot.

FIG. 3A shows an isometric view of the mobile base unit retracted within an outer shell of the robot.

FIGS. 3B-3C show side-elevation views of the mobile base unit retracted within the outer shell of the robot.

FIG. 4A shows an isometric view of the mobile base unit extended from the outer shell of the robot.

FIGS. 4B-4C shows side-elevation views of the mobile base unit extended from the outer shell of the robot.

FIG. 5 shows an example computer architecture.

FIG. 6 shows the robot laying in a horizontal position.

FIGS. 7A-7B show how extending the mobile base unit shifts the center of gravity of the robot.

FIGS. 8A-8C show how the robot is rotated from a partial upright position into a full upright position.

FIG. 9 is a flow diagram of an automated process for self-righting the robot.

### DETAILED DESCRIPTION

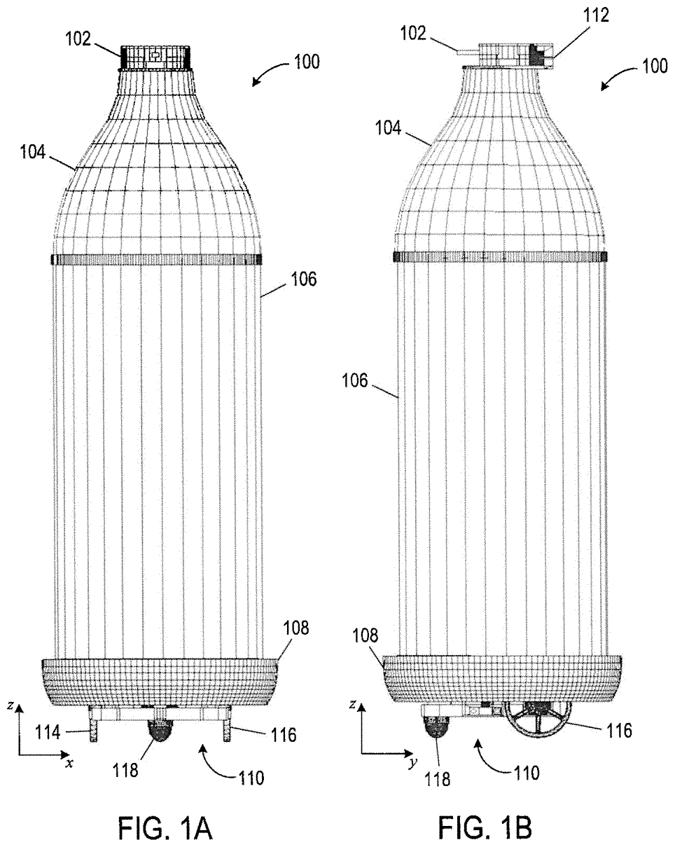

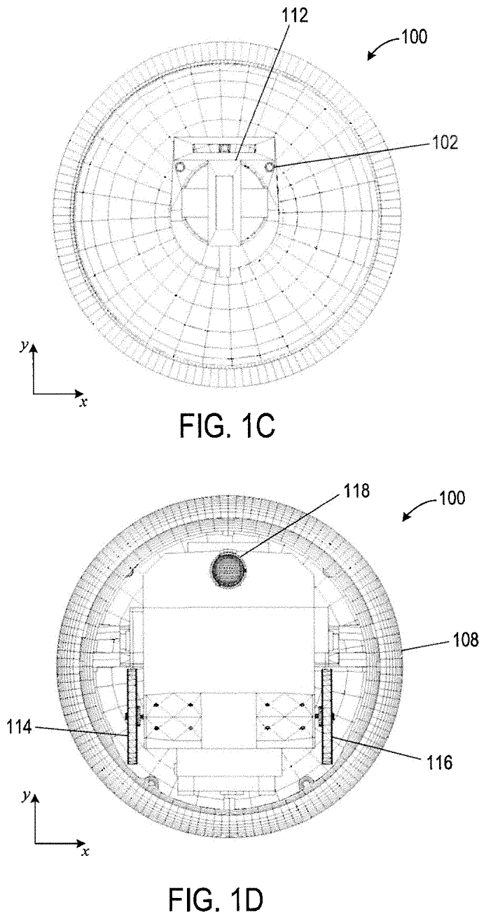

FIGS. 1A-1B show side-elevation views of an autonomous mobile robot (“robot”) 100 in an upright position. FIG. 1C shows a top view of the robot 100. FIG. 1D shows a bottom view of the robot 100. The robot 100 includes a sensor hat 102. a curved rear projection surface 104, a cylindrical body 106, and an outer shell 108, and a mobile base unit 110. The robot 100 can autonomously navigate an indoor environment, such as home environment, office environment, or hospital environment. The robot 100 detects when the robot 100 is toppled over into a horizontal position and performs automated self-righting operations that restores the robot 100 to the upright position shown in FIGS. 1A-1B.

The sensor hat 102 is located at the top of the robot 100 in the upright position shown in FIGS. 1A-1B. The sensor hat 102 includes a cluster of sensors 112. For example, in one implementation, the sensors 112 located in the sensor hat 102 include an RGB-D camera, a thermal imaging module, a microphone array for auditory sensing, and an inertial measurement unit (“IML”) sensor. The RGB-D camera is a depth camera that includes a red, green, and blue (“RGB”) color sensor and a three-dimensional depth (“D”) sensor. The RGB-D camera is a depth camera that produces depth (“D”) and color (“RGB”) data as output in real-time. Depth information is retrievable through a depth map; image created by the 3D depth sensor. The RGB-D camera performs a pixel-to-pixel merging of RGB data and depth information to deliver both in a single frame. The thermal imaging module renders infrared radiation as a visible image. The microphone array includes a number of directional microphones that are used to detect sound emitted from different directions. The IMU sensor comprises accelerometers, gyroscopes, and magnetometers. The accelerometers measure changes in acceleration in three directions and are affected by gravity. An accelerometer at rest measures an acceleration due to the Earth's gravity (e.g., about 9.8 m/s²). By contrast, when an accelerometer is in free fall, the acceleration measures about zero. The accelerometers of the IMU are used to detect when the robot 100 is in the process of falling over or toppling. The gyroscope measures orientation and angular velocity of the robot 100. The gyroscope is used to monitor rotation and velocity of the robot 100. The magnetometer measures magnetic fields and is used to determine the direction the robot 100 travels in.

The curved rear projection surface 104 is composed of a translucent plastic material, such as a translucent polyethylene terephthalate (“PET”) or biaxially-oriented PET. The mobile base unit 110 includes a projector that projects images onto the curved rear projection surface 104 from within the robot 100. A viewer can see the images projected onto the inner surface of the rear projection surface 104 from outside the robot 100.

The cylindrical body 106 is composed of an opaque material such as an opaque light weight plastic. The cylindrical body 106 provides support of the rear projection surface 104 above the outer shell 108. The cylindrical body 106 covers two or more internal support columns that are attached at one end to the outer shell 108 and at the opposite end to the outer shell 108.

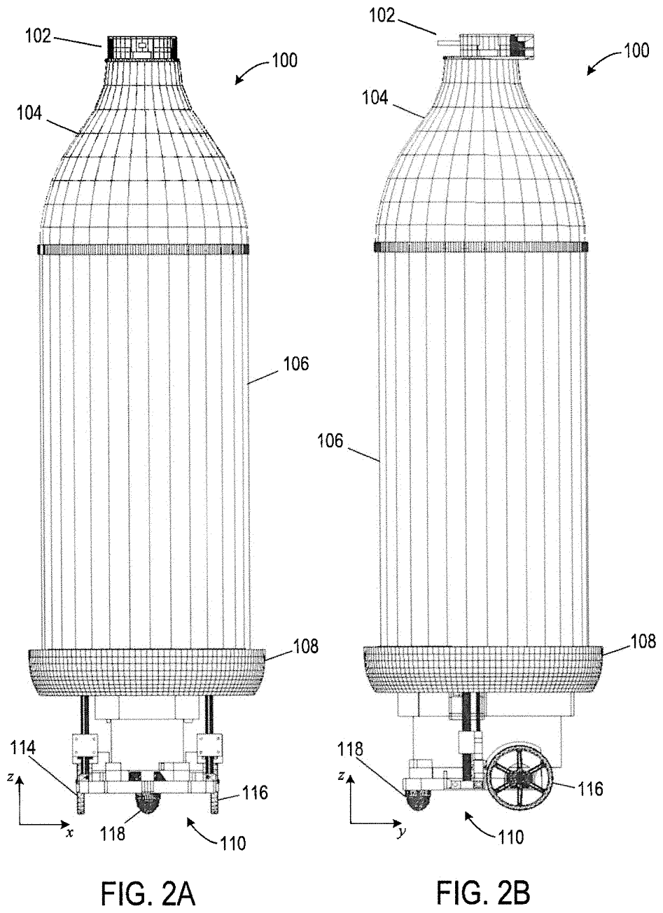

FIGS. 1A-1B and 1C show the mobile base unit 110 includes two wheels 114 and 116 and a single roller-ball wheel 118. The mobile base unit 110 enables the robot 100 to travel within a home environment, office environment, or hospital environment. The outer shell 108 is an annular ring. The outer ishape of the outer shell 108 is a spherical frustrum. The interior of the cylindrical body 106 is hollow. The mobile base unit 110 is shown partially retracted within the outer shell 108 and the cylindrical body 106, leaving the roller-ball wheel 118 and a portion of the wheels 114 and 116 exposed. The mobile base unit 110 includes linear actuators (described below) that force the mobile base unit 110 outside the cylindrical body 106, thereby increasing the height of the robot 100. FIGS. 2A-2B show two views of the mobile base unit 110 extended outside the cylindrical body to increase the overall height of the robot 100. The linear actuators are also used to retract the mobile base unit 110 to within the body of the robot 100 as shown in FIGS. 1A-1B. In one implementation, the robot 100 stands about 3 feet tall with the mobile base unit 110 retracted. When the mobile base unit 110 is extended, the height of the robot 100 may be increased to about 4 feet.

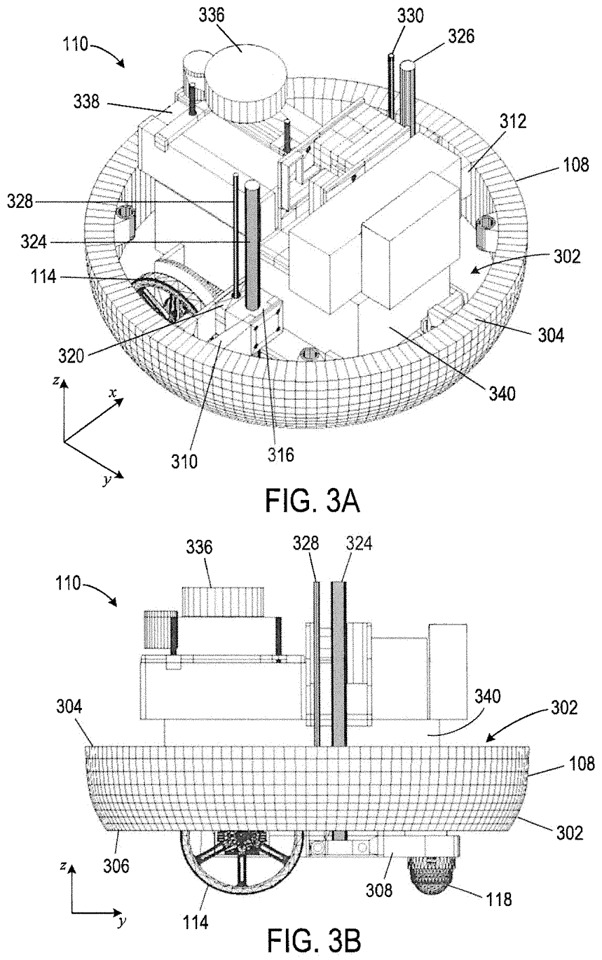

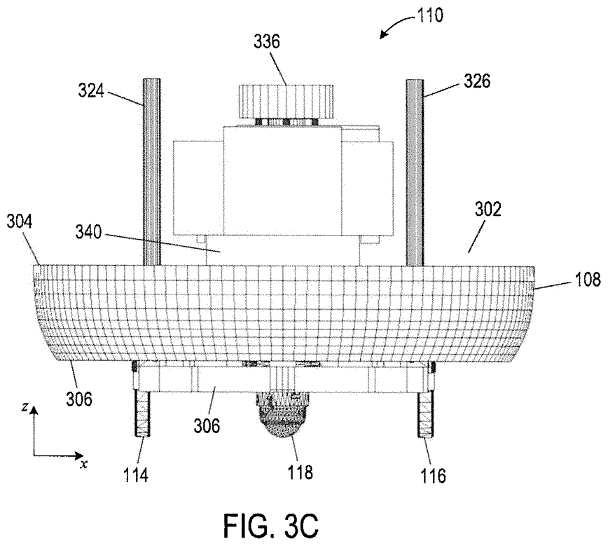

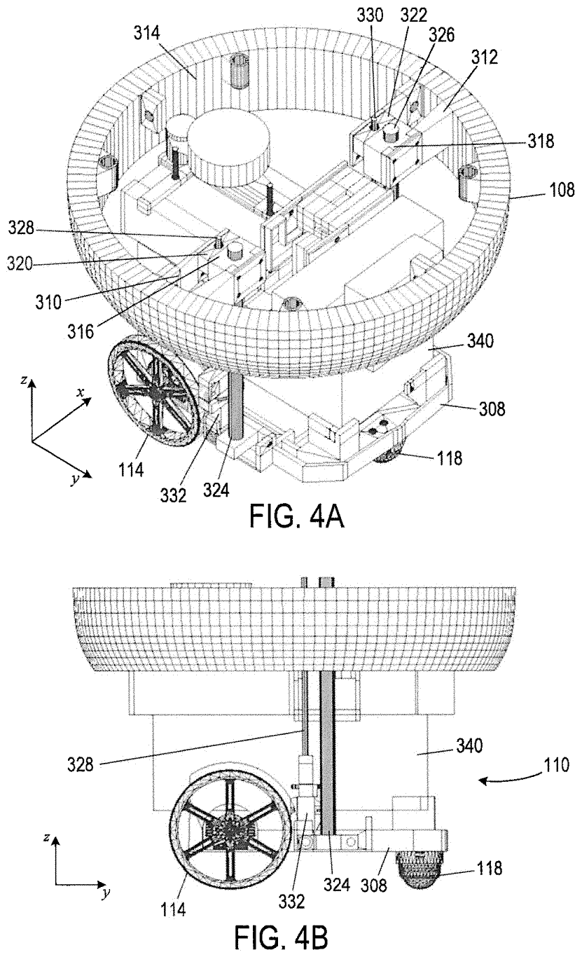

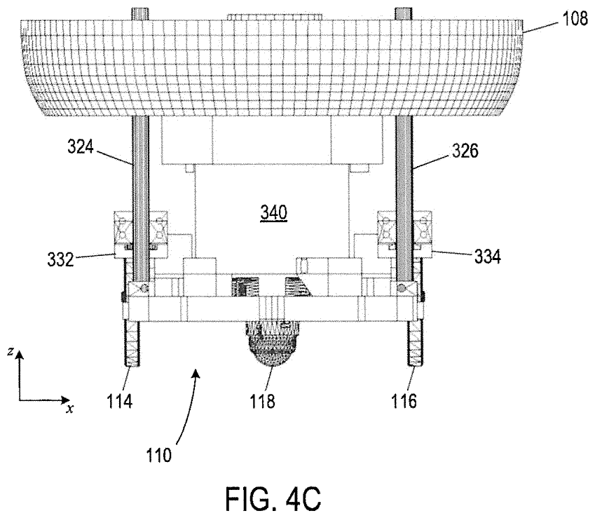

FIG. 3A shows an isometric view of the mobile base unit 110 retracted within the opening 302 of the outer shell 108. FIGS. 3B-3C show side-elevation views of the mobile base unit 110 retracted within the outer shell 108. The cylindrical body 106 is omitted to reveal the components of the mobile base unit 110. The opening 302 allows retraction and extension (see FIGS. 4A-4B) of the mobile base unit 110. The outer shell 108 includes a top surface 304 upon which the cylindrical body 106 is supported and a bottom surface 306. As shown in FIGS. 3B-3C, the exterior wall of the outer shell 108 is a smooth rounded surface 302, or curved, such that the exterior diameter of the outer shell 108 narrows toward the bottom surface 306 of the outer shell 108. In other words, the outer surface of the outer shell 108 curves inward toward the bottom of the robot 100.

FIG. 4A shows an isometric view of the mobile base unit 110 extended from the outer shell 108. FIGS. 4B-4C show side-elevation views of the mobile base unit 110 extended from the outer shell 108. As shown in FIG. 4A, brackets 310 and 312 are attached to the interior wall 314 of the outer shell 108. The brackets 310 and 312 hold linear bearings 316 and 318, respectively. The brackets 310 and 312 also hold guides 320 and 322, respectively, Rods 324 and 326 are connected at one end to a chasse 308 and pass through openings in the linear bearings 316 and 318, respectively (See FIGS. 3A and 4A). For example, FIGS. 3B, 4A, and 4B show the rod 324 connected to the chasse 308 and passes through an opening in linear bearing 316. Lead screws 328 and 330 pass through corresponding threaded openings in the guides 320 and 322, respectively. The lead screws 328 and 330 are threaded along the lengths of the screws. Each lead screw is connected at one end to a linear actuator that is attached to the chasse 308. The threads of the lead screws 328 and 330 engage the threads of the threaded openings in of the guides 320 and 322. respectively. FIGS. 4A-4B show a linear actuator 332 that rotates the lead screw 328. In FIG. 4B, the lead screw 328 is connected to linear actuator 332. The lead screw 330 is similarly connect to a linear actuator 334 shown in FIG. 4C. The linear actuator 334 rotates the lead screw 330. The lead screw 330 is connected to the linear actuator 334 in the same manner as the lead screw 328 is connected to the linear actuator 332 but on the opposite side of the mobile base unit 100.

The linear actuators 332 and 334 receive electronic signals and covert the signals into mechanical motion that rotates the lead screws 328 and 330. For example, when the mobile base unit 110 is retracted as shown in FIGS. 3A-3B, the linear actuators each receive a first signal that causes the linear actuators 332 and 334 to rotate the corresponding lead screws 328 and 330 in a first direction. The first direction of rotation pushes against the guides 320 and 322, which drives the mobile base unit 110 into the extended position shown in FIGS. 4A-4B. When the mobile base unit 110 is extended as shown in FIGS. 4A-4B. the linear actuators 332 and 334 receive a second signal that rotates the lead screws 328 and 330 in a direction of rotation that is opposite the first direction. The opposite direction of rotation pulls the guides 320 and 322, which the mobile base unit 110 into the retracted position shown in FIGS. 3A-3C.

FIGS. 3A-3C show additional components of the mobile base unit 110. The mobile base unit includes a LIDAR sensor 336, a computer 338, a battery 340, and a projector 342. The projector 342 projects images upward and onto the inner surface of the rear projection surface 104. Because the rear projection surface 104 is composed of a rigid translucent material, images are projected onto the inner rear projection surface 104 and viewed by viewers from outside the robot 100. The images can be pictures, cartoons, colorful designs, and written messages. In another implementation. the IMU sensor is located in the mobile base unit 110.

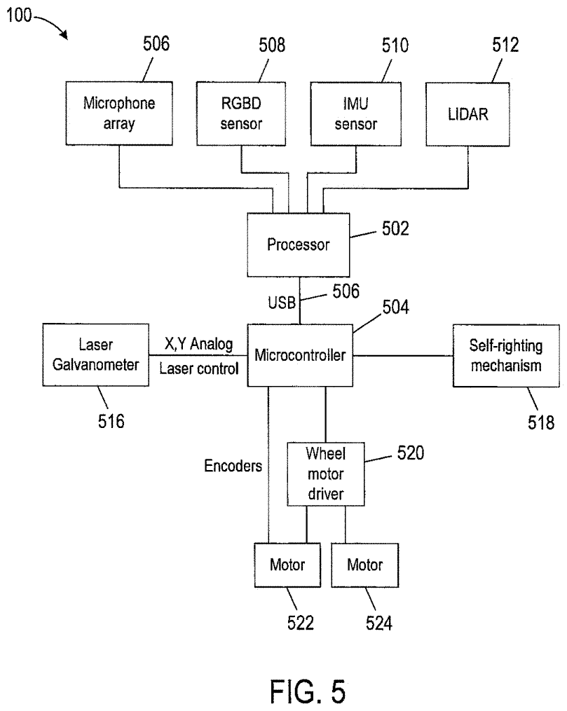

FIG. 5 shows an example computer architecture 500 of the computer 338. The architecture 500 comprises a processor 502 and a microcontroller 504. The processor 502 can be connected to the microcontroller 504 via a USB connection 506. The processor 502 is connected to a microphone array 508, an RGB-D sensor 510, an IMU sensor 510, and a LIDAR 512. The processor 502 can be a multicore processor or a graphical processing unit. The processor 502 receives signals from the microphone array 508, the RGB-D sensor 510, the IMU sensor 510, and the LIDAR 512 and the signals are sent to the microcontroller 504. The microcontroller 504 receives instructions from the processor 502. The microcontroller 504 is connected to a laser galvanometer 516, a self-righting mechanism 518, and wheel motor driver 518. The wheel motor driver 518 is connected to separate motors 522 and 524. The motors 522 and 524 separately rotate the wheels 112 and 114 to control speed, turning, and rotation of the robot 100 as the robot 100 travels and navigates its way in a home, office, or hospital environment. The self-right mechanism 518 comprises the linear actuators 332 and 334 and the outer shell 108. The surface of the outer shell 108 provides the fulcrum for rotating the robot 100 away from horizontal to a tilted position as explained below.

The microcontroller 504 is an integrated circuit that executes specific control operations performed by the actuators 332 and 334 of the self-righting mechanism 518, wheel motor driver 520, and the galvanometer 516. The microcontroller 504 includes a processor, memory, and input/output (I/O) peripherals. The microcontroller 504 interprets the signals received from the processor 502 using its own processor. The data that the microcontroller 504 receives is stored in its memory, where the processor accesses the data and uses instructions stored in program memory to decipher and execute the instructions for operating self-righting of the robot 100 described below. The microcontroller 504 uses I/O peripherals to control of the actuators 332 and 334 of the self-right mechanism 518 as described below.

The robot 100 is normally operated in an upright position with the mobile base unit 110 retracted, as shown in FIGS. 1A-1B. The IMU sensor 510 combines accelerometer, gyroscope, and magnetometer functions into one device that measures gravity, orientation, and velocity on the robot 100. The accelerometer of the IMU sensor 510 detects when the robot 100 is falling onto its side. The processor 502 receives gravity measurement (i.e., zero m/s²) from the accelerometer and determines that the robot 100 has fallen over.

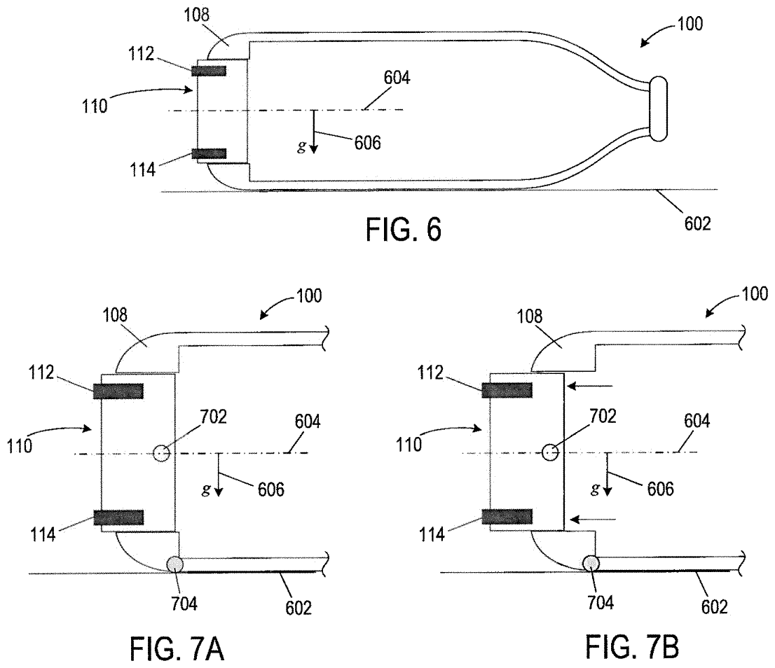

FIG. 6 shows an example of the robot 100 laying in a horizontal position. Horizontal line 602 represents a floor or surface. Dot-dashed line 604 represents the central axis of the robot 100. Directional arrow 606 represents the direction of gravity. The heaviest components, such as motors, battery. computer, projector, LIDAR, wheels, and chasse, of the robot 100 are located in the mobile base unit 110. As result, the center of gravity of the robot 100 is located in the mobile base unit 110. The microcontroller 504 sends a first signal that drives the linear actuators 332 and 334 to rotate the lead screws 328 and 330 in a first direction which slowly moves the mobile base unit 110 outward from the opening 302 of the outer shell 108 along the central axis 604 into the extended position. As the mobile base unit 110 moves outward along the central axis 604, the center of gravity of the robot 100 shifts.

FIGS. 7A-7B show how extending the mobile base unit 110 shifts the center of gravity of robot 100. In FIG. 7A, the mobile base unit 110 is retracted within the robot 100. Light shaded circle 702 identifies the center of gravity of the robot 100. Dark shaded circle 704 identifies the fulcrum, which is located where the outer shell 108 touches the floor 602. Note that the when the mobile base unit 110 is retracted and the robot 100 is horizontal, the center of gravity 702 is nearly vertically aligned with the fulcrum 704. In FIG. 7B, the self-righting mechanism 518 engages the linear actuators to slowly extend the mobile base unit 110 outward from the opening 302 of the outer shell 108 along the central axis 604. As the center of gravity 702 slowly shifts away from near alignment with the fulcrum 704, gravity causes the robot 100 to slowly rotate upward into a tilted position. In other words, because the center of gravity 702 is extended beyond near vertical alignment with the fulcrum 704, gravity creates a torque at the fulcrum 704. The robot 100 slowly rotates along the curved outer surface of the outer shell 108 as the mobile base unit 110 is extended, moving the robot 100 into a partial upright, or tilted, position.

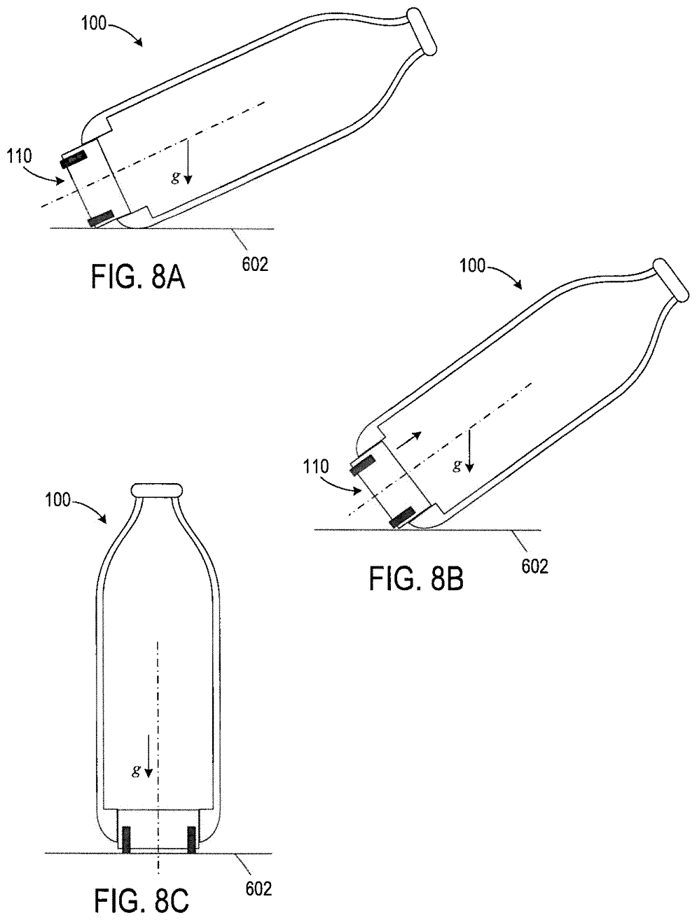

FIGS. 8A-8C show how the robot 100 is rotated from a partial upright position into a full upright position. In FIG. 8A, the mobile base unit 110 is extended and the robot 100 has stopped rotating because the mobile base unit 110 contacts the floor 602. The gyroscope of the IMU sensor 410 detects velocity of upward rotation and the titled orientation of the robot 100. The gyroscope sends a signal to the processor 502 indicating that the robot 100 is in a stopped tilted position. The processor 502 sends a second signal to the self-righting mechanism 418 to slowly retract the mobile base unit 110 into the opening 302 of the outer shell 108 along the central axis 604 as shown in FIG. 8B. The linear actuators 332 and 334 receive the second signal that rotates the lead screws 328 and 330 in an opposite rotation of the first direction. As the mobile base unit 110 retracts into the body of the robot 100. the center of gravity moves toward the inside of the robot 100, causing the robot 100 to slowly rotate along the curved surface of the outer shell 108 from the tilted position to the full upright position shown in FIG. 8C.

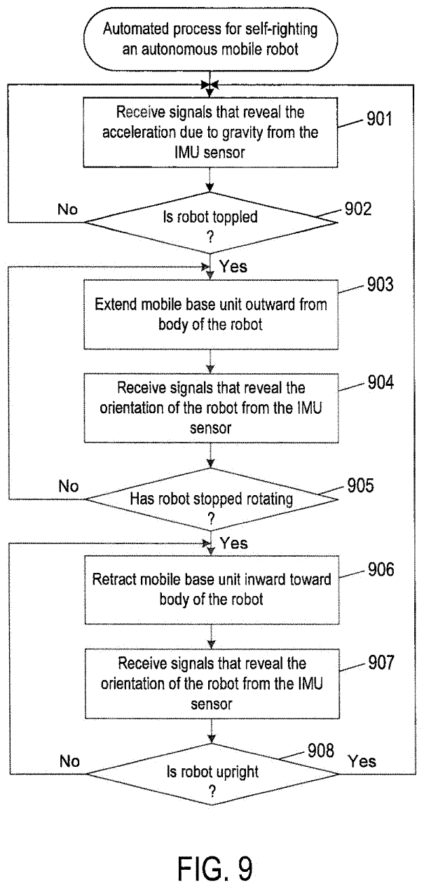

FIG. 9 is a flow diagram of an automated process self-righting a robot. In block 901, the processor 502 receives signals regarding the acceleration of gravity from the IMU sensor 510. In decision block 902, in response to the signals indicating the acceleration of gravity is nearly zero m/s² (i.e., the robot 100 is in the process of falling over). the processor sends information to the microcontroller 504 that the robot 100 is horizontal and control flows to block 903. In block 903, the microcontroller 504 sends first signals causing the actuators 332 and 334 to extend the mobile base unit 110 outward from the body of the robot 100. In block 904, the processor 502 receives signals regarding the orientation and velocity of robot 100 from the IMU sensor 510. In decision block 905, in response to the signals indicating the robot 100 has stopped rotating (i.e., orientation of the robot 100 is tilted and the velocity is zero as shown in FIG. 8A), the processor sends information to the microcontroller 504 that the robot 100 has stopped rotating and control flows to block 906. In block 906, the microcontroller 504 sends second signals causing the actuators 332 and 334 to retract the mobile base unit 110 inward toward the inside of the body of the robot 100. In block 907, the processor 502 receives signals regarding the acceleration of gravity from the IMU sensor 510. In decision block 908, in response to the signals indicating the acceleration of gravity is nearly 9.8 m/s² (i.e., the robot 100 is upright), the processor continues to monitor the signals emitted from the IMU sensor 510.

It is appreciated that the previous description of the disclosed embodiments is provided to enable any person skilled in the art to make or use the present disclosure. Various modifications to these embodiments will be apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. An autonomous mobile robot, the robot comprising:
an IMU sensor that measures acceleration, orientation, and velocity of the robot;
an annular outer shell having an opening and an outer surface that curves inward toward the bottom of the robot; and
a mobile base unit attached to an inner wall of the outer shell, the mobile base unit including:
wheels, separate motors that drive the wheels, linear actuators attached to the inner wall and can extend the mobile base unit outward from the opening of the outer shell and retract the mobile base unit to within the opening of the outer shell, and a computer,
wherein the computer, in response to receiving acceleration, orientation, and velocity signals from the IMU sensor, detects when the robot is toppled over from an upright position and uses the actuators to extend and retract the mobile base unit to restore the robot to an upright position.

2. The robot of claim 1 wherein the center of mass of the robot is in the mobile base unit.

3. The robot of claim I wherein the actuators and the outer surface of the outer shell that curves inward toward the bottom of the robot form a self-righting mechanism for rotating the robot to the upright position.

4. The robot of claim 1 wherein the computer includes a microcontroller that sends a first signal to the actuators that drives the linear actuators to move the mobile base unit outward from the opening and sends a second signal to the linear actuators that drives the linear actuators to move the mobile base unit inward through the opening.

5. The robot of claim 1 further comprising:
brackets attached to an inner wall of the opening in the outer shell;
guides attached to the brackets, each guides having a threaded opening; and
threaded lead screws, each threaded lead screw attached at one end to one of the linear actuators and engages the threaded opening of one of the guides.

6. An automated method, stored in memory of a microcontroller of an autonomous mobile robot and executed by a processor of the microcontroller, for self-righting the robot, the method comprising:
monitoring orientation of the robot using an internal measurement unit (“IMU”) sensor located within the robot;
in response to detecting that the robot is falling over based on signals output from the IMU sensor, extending a mobile base unit of the robot causing the robot to rotate into a tilted upright position; and
in response to detecting that the robot is tilted and has stopped rotating based on signals output from the IMU sensor, retracting the mobile base unit of the robot causing the robot to rotate into a full upright position.

7. The method of claim 6 wherein monitoring orientation of the robot using the IMU sensor located within the robot comprises receiving acceleration of gravity data from an accelerometer of the IMU sensor.

8. The method of claim 6 wherein monitoring orientation of the robot using the IMU sensor located within the robot comprises receiving orientation and velocity data of the robot from a gyroscope of the IMU sensor.

9. The method of claim 6 wherein extending the mobile base unit of the robot causing the robot to rotate into a tilted upright position comprises engaging linear actuators of the robot to extend the mobile base unit outward from the robot along the central axis of the robot, causing the center of gravity of the robot to shift outward from the robot and the robot to rotate into the tilted upright position along a curved surface of the robot.

10. The method of claim 6 wherein retracting the mobile base unit of the robot causing the robot to rotate into a full upright position comprises engaging linear actuators of the robot to retract the mobile base unit inward along the central axis of the robot, causing the center of gravity of the robot to shift inward and the robot to rotate from the tilted position to the full upright position.
